(19) United States
(12) Patent Application Publication
(10) Pub. No.: US 2009/0151798 A1
(43) Pub. Date: Jun. 18, 2009

(54) IRRIGATION SYSTEM EMITTER

(76) Inventor: FRED H. HARNED, Orlando, FL (US)

Correspondence Address: PROSKAUER ROSE LLP, ONE INTERNATIONAL PLACE, BOSTON, MA, 02110, US

(21) Appl. No.: 11/957,789

(22) Filed: Dec. 17, 2007

(51) Int. Cl. F16K 21/04; A01G 25/00

(52) U.S. Cl. 137/513.3; 47/79

(57) ABSTRACT

The current invention provides a emitter with an internal passage for a drip irrigation system that delivers an irrigation fluid such as water from a fluid source to one or more plants. The emitter is capable of being operably attached to a tube or other conduit of an irrigation fluid. Optionally, the emitter includes a means for reversibly attaching a side portion of a tube to the emitter.

### FIELD OF THE INVENTION

The invention provides an apparatus for use in an irrigation system.

### BACKGROUND OF THE INVENTION

Irrigation systems for plants, flowers, vegetables and other biological systems requiring water provide a continuing or periodic supply of moisture to the plants. Above-ground type irrigation systems include sprinkler systems that distribute water over a generally broad area and often require either the installation of permanent water lines and hardware or require the hardware to adapt to the irrigation needs of various plant configurations. The water distributed from sprinkler-type irrigation systems is directed over a general area and not directed to the roots of a particular plant, requiring use of excessive quantities of water. Alternative ground-based irrigation systems include porous hoses that seep water through the hose wall or that have apertures that emit a stream of water when the hose is under pressure. Such hoses often result in excess water usage and require excessive lengths to meet the irrigation needs of many plants and may result in damage to delicate foliage when placing, removing or relocating the hoses.

Because of these limitations, drip irrigation systems have been developed in which one or more lines or tubes emanating from an irrigation fluid supply individually terminate at a discharge device, termed an emitter. Dramm et al. disclosed an emitter having an elongated member with multiple internal passages generally in the form of a “T” with one fluid inlet and two lateral fluid discharge outlets, which are located at approximately the longitudinal midpoint of the emitter. (See, U.S. Pat. No. 6,695,231). However, the number, size and placement of the discharge outlets increases the likelihood of clogging the emitter. For example, the placement of the discharge outlets at the midpoint of the emitter can result in the blocking of these discharge outlets when the emitter is inserted into the soil, or plant roots growing into and thereby blocking the discharge outlets. Also, there is a lack in the Dramm emitter of an individual shut-off mechanism, resulting in water and fertilizer waste and damage to plants from over-watering. Emitters that are fabricated out of iron or other metals suffer from oxidation and other corrosive chemical reactions in the presence of water or other liquids or soil, resulting in the leaching of toxic metal compounds into the soil and an unattractive appearance of the emitter. Metal-fabricated emitters are also sensitive to fluctuations in the price and availability of the metals, thereby requiring substantial investments in purchasing and warehousing these metals, and causing insecurity as to the availability of critical components in the fabrication process.

In view of the foregoing, it would be desirable to provide an emitter for a drip irrigation system that is resistant to clogging by dirt or plant material, where each emitter device can be easily and quickly shut off, preferably with one hand, and easily installed or removed without damaging the plant. It is also desirable to provide an emitter that contains a metal core, giving the emitter a high specific gravity so as to keep the emitter firmly in place, and the metal core is encased in a synthetic cover, providing corrosion resistance, a uniform appearance, and the ability of the manufacturer to substitute core metals based on pricing and availability.

### SUMMARY OF THE INVENTION

In general, aspects of the present invention relate to components of irrigations systems having novel configurations. In one aspect, the invention provides an emitter containing a body portion having an external surface extending between a first end and a second end, a first passage extending in a proximal-distal orientation from the first end towards the second end of the body portion, a second passage extending from the external surface to the first passage, whereby the first passage and second passage are operably linked, an entry portion on the first end of the body portion including an entry opening operably linked to the first passage and a tube end attachment means, and a tube side attachment means disposed on a surface of the external wall. In certain embodiments, the first passage and second passage each have substantially curved surfaces, and the diameter of the second passage is greater than the diameter of the first passage. In other embodiments, the second passage extends radially from the external surface to the first passage, and the second passage is located closer to the first end of the body portion than the second end of the body portion. In other embodiments, the second passage is adjacent to the entry opening. In some embodiments, the tube end attachment means includes at least one external circumferential ridge configured to engage an interior of the tube. In these embodiments, providing an emitter with the second passage forming an outlet for water or other liquids roughly adjacent to the entry opening to which the tube is connected is useful in that the emitter will be placed with the second end in or on the soil, reducing the chance of soil or plant material entering the outlet. The combination of the first passage and the second passage creates an L-shaped passage. At least a section of the body portion has a substantially cylindrical external shape. In a further embodiment, the tube side attachment means contains two wall surfaces projecting away from the body portion, and the wall surfaces are positioned so as to form a channel into which a tube can be retainably placed. Optionally, the wall surfaces are tapered such that the proximal end of each wall surface relative to the first end of the body portion is shorter than the distal end of each wall surface. These tapered wall surfaces reduce the likelihood of snagging the emitter on the plant when the emitter is inserted or removed. In some embodiments, the second end of the body portion is closed. In other embodiments, the distance between the first end and the second end is about fifty millimeters (two inches). In further embodiments, the distance between the first end and the second passage is about twenty millimeters (about three-quarters of an inch) or less. The emitter is optionally formed of a metallic material core surrounded by a synthetic cover, thereby providing corrosion resistance, a uniform appearance, and the ability of the manufacturer to substitute core metals based on pricing and availability. In another embodiment, the center of gravity along a proximal-distal orientation relative to the first and second ends is closer to the second end than the first end.

In a second aspect, the invention provides an emitter that contains a body portion having an external surface extending between a first end and a second end, a first passage extending in a proximal-distal orientation from the first end towards the second end of the body portion, a second passage extending from the external surface to the first passage, where the first passage and second passage are operably linked, thereby creating an L-shaped passage, an entry portion on the first end of the body portion including an entry opening operably linked to the first passage and a tube end attachment means. In certain embodiments, the first passage and second passage each have substantially circular surfaces, and the diameter of the second passage is greater than the diameter of the first passage. In other embodiments, the second passage extends radially from the external surface to the first passage, and the second passage is located closer to the first end of the body portion than the second end of the body portion.

In a third aspect, the invention provides an apparatus for a drip irrigation system that includes at least one fluid flow regulation device, at least one elongated member having an internal passage adapted to couple to the flow regulation device, and an emitter that contains a body portion having an external surface extending between a first end and a second end, a first passage extending in a proximal-distal orientation from the first end towards the second end of the body portion, a second passage extending from the external surface to the first passage, where the first passage and second passage are operably linked, an entry portion on the first end of the body portion including an entry opening operably linked to the first passage and a tube end attachment means, and a tube side attachment means disposed on a surface of the external wall. In some embodiments, the elongated member is a flexible, non-porous tube, and the fluid flow regulation device has a means for connection to an irrigation fluid supply source.

In a fourth aspect, the invention provides a method of irrigating a plant by providing an apparatus for a drip irrigation system that includes at least one fluid flow regulation device, at least one elongated member having an internal passage adapted to couple to the flow regulation device, and an emitter that includes a body portion having an external surface extending between a first end and a second end, a first passage extending in a proximal-distal orientation from the first end towards the second end of the body portion, a second passage extending from the external surface to the first passage, where the first passage and second passage are operably linked, an entry portion on the first end of the body portion containing an entry opening operably linked to the first passage and a tube end attachment means, and a tube side attachment means disposed on a surface of the external wall, and positioning the emitter on or at least partially in a support medium surrounding the plant. The invention also includes a plant irrigated by this method.

Unless otherwise defined, all technical and scientific terms used herein have the same meaning as commonly understood by one of ordinary skill in the art to which this invention belongs. Although methods and materials similar or equivalent to those described herein can be used in the practice or testing of aspects of the present invention, suitable methods and materials are described below. All publications, patent applications, patents, and other references mentioned herein are incorporated by reference in their entirety. In the case of conflict, the present specification, including definitions, will control. In addition, the materials, methods, and examples are illustrative only and are not intended to be limiting.

### DESCRIPTION OF THE DRAWINGS AND FIGURES

The present invention may be further appreciated with reference to the appended drawing sheets wherein:

FIG. 1 is a perspective view of an emitter of the present invention.

FIG. 2 is a perspective view of an emitter of the present invention.

FIG. 3 is a cross-sectional view of an emitter of the present invention.

FIG. 4A is a perspective view of an apparatus for a drip irrigation system of the present invention. FIG. 4B is a perspective view of an emitter of the present invention with a tube engaged in the tube side attachment means of the emitter.

Other objects, features, and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

In some embodiments described herein, the present invention relates generally to a device useful as an emitter for a liquid irrigation system, and an apparatus for a drip irrigation system. The emitter is useful in distributing fluids (e.g., water, liquid fertilizer, etc.) to one or more plants or other biological systems.

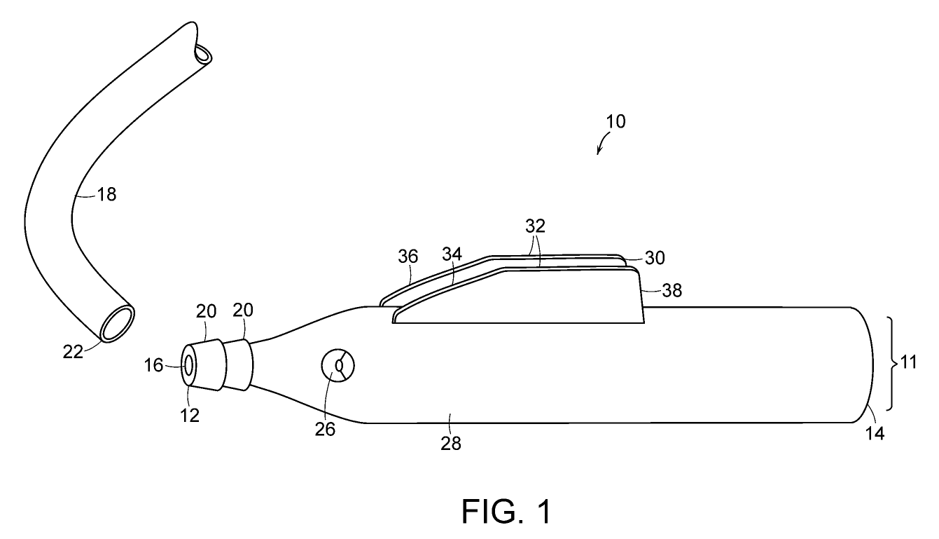

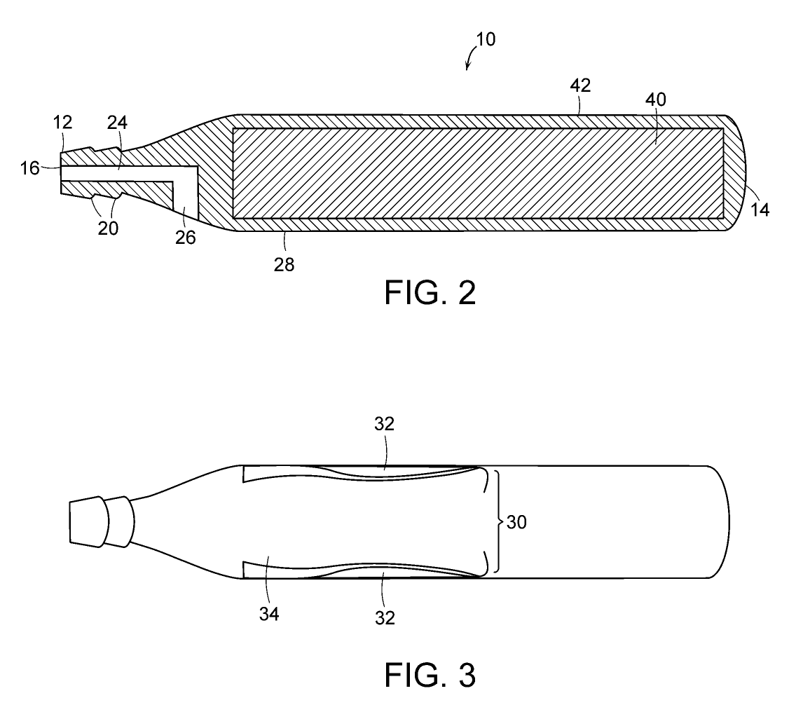

Referring to FIG. 1, an emitter 10 is shown. In one embodiment the emitter 10 has a body portion 11 including a first end 12 and a second end 14. At the first end 12 is an entry portion having an opening, termed a fluid inlet 16, having a generally circular shape for receiving irrigation fluids from an elongated member such as a flexible tube 18. The emitter 10 includes a tube attachment means for connecting the emitter 10 to the tube 18. For example, the tube attachment means may include one or more circumferential ridges at first end 12 are shown schematically as barbs 20, improve the retention of an end 22 of the flexible tube 18. In operational linkage with the fluid inlet 16 is a first passage, termed the inlet passage 24 that has two ends and extends from the fluid inlet 16 towards the second end 14 of the emitter. The inlet passage 24 generally extends in a linear direction from the fluid inlet 16 and has a generally circular shape roughly the same diameter as fluid inlet 16. Preferably, the inlet passage 24 extends from the first end 12 in a proximal-distal orientation towards the second end 14 of the body portion 11. The inlet passage 24 terminates at a second passage, termed the outlet passage 26, that extends to the inlet passage 24 from an exterior surface 28 of the emitter 10. In certain embodiments the body portion 11 of the emitter is roughly cylindrically shaped and the inlet passage 24 encompasses the center of this cylindrical shape. The outlet passage 26 may extend from the inlet passage in a radial direction. Inlet passage 24 and outlet passage 26 may be formed in the shape of an “L”. In alternative embodiments, the inlet and outlet passages may be provided in any geometric shape that results in a liquid flow pattern suitable for providing a fluid discharge path. Preferably, the inlet passage 24 and outlet passage 26 each have substantially curved surfaces, such that each passage is defined by a substantially cylindrical geometry. Advantageously, when the inlet passage 24 and outlet passage 26 are cylindrically shaped, the diameter of the outlet passage 26 is greater than the diameter of the inlet passage 24, such that the flow rate of a liquid traveling from the fluid inlet 16 through the inlet passage 24 is greater than the flow rate of a liquid traveling through the outlet passage 26. Reduction of the flow rate of the fluid entering the plant or soil is useful to minimize the potential for displacement of the soil or other medium surrounding the plant.

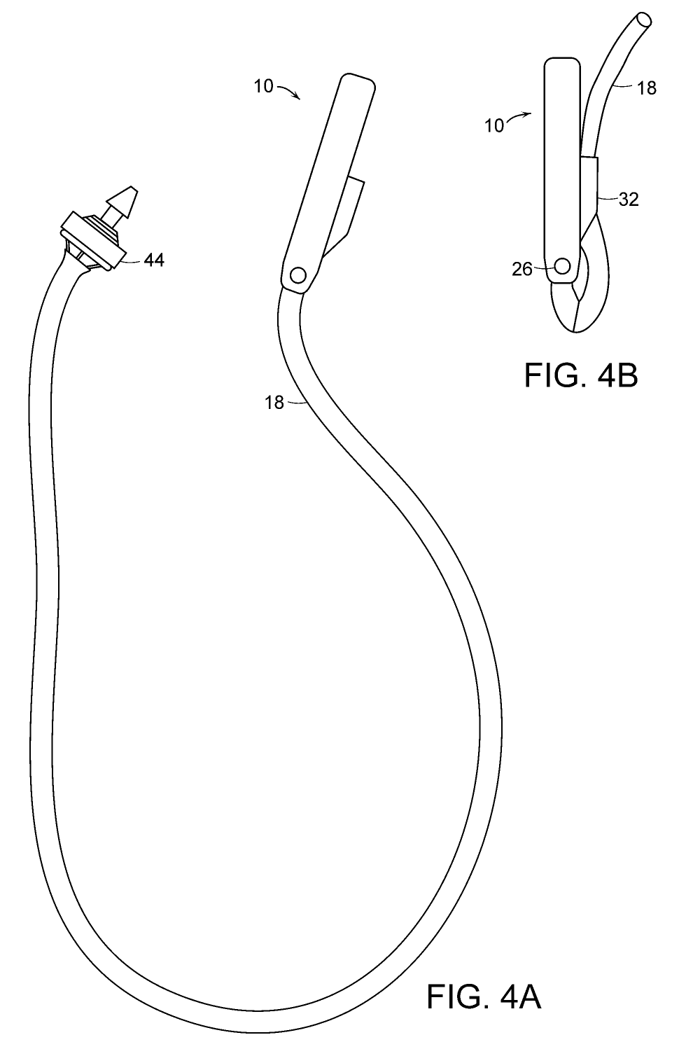

It is advantageous for the emitter device of the invention to be easily and quickly shut off, preferably with one hand. The emitter shown in FIG. 1 contains a tube side attachment means 30 disposed on the exterior surface 28. The tube side attachment means includes two wall surfaces 32 that project away from the body portion 11. These wall surfaces 32 are positioned so as to form a channel 34 into which tube 18 can be retainably placed. An exemplary depiction of a closed-off drip irrigation system apparatus is shown in FIG. 4B, in which a portion of the tube 18 has been inserted between the wall surfaces 32 and into channel 34. The wall surfaces 32 are optionally curved to assist in retention of the tube 18. The wall surfaces 32 are tapered such that the height of the proximal end 36 of each wall surface 32 relative to the first end 12 of the body portion 11 proximal end is less than the height of the distal end 38 of each wall surface 32. An advantage of having tapered wall surfaces 32 is that the wall surfaces are less likely to catch or snag part of the plant when the emitter 10 is removed. For the same reason it is advantageous that the first end 12 of the emitter is tapered and similarly smaller than the second end 14.

Generally, the emitter is placed on or at least partially in a support medium surrounding the plant to provide a drip irrigation source of fluid. Usually the support medium is soil or other nutritive solid material. Other support mediums known in the art, such as sand, gels and other semi-solid materials, are also included in the present invention. Further, in the practice of hydroponic agriculture the emitter can be placed in or near the fluid surrounding the plant, for the addition of water, liquid fertilizer, and the like. Alternatively, the emitter 10 is placed within the foliage of the plant. In some embodiments, the emitter 10 is weighted to improve its retention at the irrigation location of the plant. For example, the emitter 10 may contain an inner material, termed a core 40, surrounded by an exterior material, termed a cover 42. In certain embodiments, the cover 42 is a synthetic material such as a plastic. Often, the core 40 is a metallic or other material with a higher density than the cover 42, and is positioned such that the center of gravity of the emitter is closer to the second end than the first end of the emitter. In embodiments where the core 40 is a metal such as iron that corrodes (e.g., oxidizes) in the presence of water or other liquids, the cover 42 prevents such corrosion. The material used to form the core 40 is completely obscured by the cover 42, so that this material can be substituted with another suitable material based on market conditions.

The emitter 10 has a length (as measured from the first to the second end) of between about five (5) and one hundred (100) millimeters, such as between about 10 and 80 millimeters, 20 and 70 millimeters, or 40-60 millimeters. In one embodiment the emitter is about 55.5 millimeters in length. The emitter 10 at a region distal to the side attachment means has an external diameter of about 9.5 millimeters excluding the side attachment means, and an external diameter of about 14 millimeters including the side attachment means.

The emitter 10 may have any suitable weight to correspond to the resiliency of the tube 18 and to allow installation in, or removal from, a plant without damaging or injuring the plant. For example, the emitter 10 weighs between one and over fifty grams, such as between 5-25 grams, or 10 and 15 grams. In a specific embodiment the emitter 10 weighs about eleven grams.

Referring to FIG. 4A, the emitter of the invention can be provided as part of an apparatus for a drip irrigation system. This apparatus contains an emitter 10, at least one fluid flow regulation device 44, and at least one elongated member having an internal passage adapted to couple to the flow regulation device, depicted in FIG. 4A as a flexible non-porous tube 18. The fluid flow regulation device 44, which is also termed a pressure compensator, a pressure compensating emitter or a dripper, is operably linked to a irrigation fluid supply source, such as a water tank or supply pipe, and is useful to provide a constant flow rate of water or other liquid, including under circumstances wherein the pressure of the fluid entering from the supply source into the fluid flow regulation device 44 is variable over time. For example, the fluid flow regulation device 44 is capable of receiving water and other fluids at high pressure and delivering the same fluid at a lower pressure. The fluid flow regulation device 44 is capable of operating at pressures of below 5 pounds per square inch (psi) to above 55 psi. The fluid flow regulation device preferably includes a means for connection to an irrigation fluid supply source, such as a container, reservoir, or the like.

The apparatus for a drip irrigation system is useful for irrigating plants, flowers, trees, shrubs, vegetables, and other biological systems. The apparatus is positioned such that the flow regulation device is operably linked to a source of water or other fluid. The emitter of the apparatus is positioned on or at least partially in a support medium surrounding the plant. For example, if the plant is surrounded by soil, the emitter is placed with the second end inserted into the soil near the plant. As described herein, in some embodiments the emitter is about fifty millimeters in length, as measured from the first end to the second end, and the distance between the first end and the second passage is about twenty millimeters or less. For example, the distance between the first end and the center of the second passage is 12 millimeters. In such a configuration a portion of the emitter body can be placed in the soil, thereby increasing the security of the placement of the emitter and decreasing the movement of the emitter, which could result in damage to the plant. Such a configuration also decreases the risk of clogging the second passage with soil.

The present invention is not limited to the particular methodologies, protocols, constructs, formulae and reagents described but further include those known to the skilled artisan. It is also to be understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Any methods, devices, and materials similar or equivalent to those described herein can be used in the practice or testing of the invention. All publications and patents mentioned herein are incorporated herein by reference.

What is claimed is:

1. An emitter comprising:
a body portion having an external surface extending between a first end and a second end;
a first passage extending in a proximal-distal orientation from the first end towards the second end of the body portion;
a second passage extending from the external surface to the first passage, whereby the first passage and second passage are operably linked;
an entry portion on the first end of the body portion comprising an entry opening operably linked to the first passage and a tube end attachment means; and
a tube side attachment means disposed on a surface of the external wall.

2. The emitter of claim 1, wherein the first passage and second passage each have substantially curved surfaces, and wherein the diameter of the second passage is greater than the diameter of the first passage.

3. The emitter of claim 1, wherein the second passage extends radially from the external surface to the first passage, and wherein the second passage is located closer to the first end of the body portion than the second end of the body portion.

4. The emitter of claim 1, wherein the second passage is located adjacent to the entry opening.

5. The emitter of claim 1, wherein the tube end attachment means comprises at least one external circumferential ridge configured to engage an interior of the tube.

6. The emitter of claim 1, wherein the combination of the first passage and the second passage creates an L-shaped passage.

7. The emitter of claim 1, wherein at least a section of the body portion has a substantially cylindrical external shape.

8. The emitter of claim 1, wherein the tube side attachment means comprises two wall surfaces projecting away from the body portion, wherein the wall surfaces are positioned so as to form a channel into which a tube can be retainably placed.

9. The emitter of claim 7, wherein the wall surfaces are tapered such that the proximal end of each wall surface relative to the first end of the body portion is shorter than the distal end of each wall surface.

10. The emitter of claim 1, wherein the body portion is tapered such that the first end is smaller than the second end.

11. The emitter of claim 1, wherein the distance between the first end and the second end is about fifty millimeters.

12. The emitter of claim 1, wherein the distance between the first end and the second passage is about twenty millimeters or less.

13. The emitter of claim 1, wherein the emitter comprises a metallic material core surrounded by a synthetic cover.

14. The emitter of claim 1, wherein the center of gravity along a proximal-distal orientation relative to the first and second ends is closer to the second end than the first end.

15. An emitter comprising:
a body portion having an external surface extending between a first end and a second end;
a first passage extending in a proximal-distal orientation from the first end towards the second end of the body portion;
a second passage extending from the external surface to the first passage, whereby the first passage and second passage are operably linked, thereby creating an L-shaped passage;
an entry portion on the first end of the body portion comprising an entry opening operably linked to the first passage and a tube end attachment means.

16. The emitter of claim 15, wherein the first passage and second passage each have substantially circular surfaces, and wherein the diameter of the second passage is greater than the diameter of the first passage.

17. The emitter of claim 15, wherein the second passage extends radially from the external surface to the first passage, and wherein the second passage is located closer to the first end of the body portion than the second end of the body portion.

18. The emitter of claim 15, further comprising a tube side attachment means disposed on the external surface.

19. The emitter of claim 18, wherein the tube side attachment means comprises two wall surfaces projecting away from the body portion, wherein the wall surfaces are positioned so as to form a channel into which a tube can be retainably placed.

20. The emitter of claim 19, wherein the wall surfaces are tapered such that the proximal end of each wall surface relative to the first end of the body portion is shorter than the distal end of each wall surface.

21. The emitter of claim 15, wherein the body portion is tapered such that the first end is smaller than the second end.

22. An apparatus for a drip irrigation system, comprising:
at least one fluid flow regulation device;
at least one elongated member having an internal passage adapted to couple to the flow regulation device; and
an emitter comprising:
a body portion having an external surface extending between a first end and a second end;
a first passage extending in a proximal-distal orientation from the first end towards the second end of the body portion;
a second passage extending from the external surface to the first passage, whereby the first passage and second passage are operably linked;
an entry portion on the first end of the body portion comprising an entry opening operably linked to the first passage and a tube end attachment means; and
a tube side attachment means disposed on a surface of the external wall.

23. The apparatus of claim 22, wherein the elongated member is a flexible, non-porous tube, and the fluid flow regulation device comprises a means for connection to an irrigation fluid supply source.

24. A method of irrigating a plant, comprising:
i) providing an apparatus for a drip irrigation system comprising:
a) at least one fluid flow regulation device;
b) at least one elongated member having an internal passage adapted to couple to the flow regulation device; and
c) an emitter comprising:
a body portion having an external surface extending between a first end and a second end;
a first passage extending in a proximal-distal orientation from the first end towards the second end of the body portion;
a second passage extending from the external surface to the first passage, whereby the first passage and second passage are operably linked;
an entry portion on the first end of the body portion comprising an entry opening operably linked to the first passage and a tube end attachment means; and
a tube side attachment means disposed on a surface of the external wall; and
ii) positioning the emitter on or at least partially in a support medium surrounding the plant.

25. A plant irrigated by the method of claim 24.
